(19) United States
(12) Patent Application Publication
(10) Pub. No.: US 2025/0065267 A1
(43) Pub. Date: Feb. 27, 2025

(54) EXHAUST GAS TREATMENT DEVICE AND SMALL COMBUSTION INSTALLATION EQUIPPED THEREWITH

(71) Applicant: Fraunhofer-Gesellschaft zur Förderung der angewandten Forschung e.V., Munich (DE)

(72) Inventor: Mohammadshayesh Aleysa, Stuttgart (DE)

(73) Assignee: Fraunhofer-Gesellschaft zur Förderung der angewandten Forschung e.V., Munich (DE)

(21) Appl. No.: 18/938,804

(22) Filed: Nov. 6, 2024

Related U.S. Application Data
(63) Continuation of application No. PCT/EP2023/062728, filed on May 12, 2023.

(30) Foreign Application Priority Data
May 16, 2022 (DE) 10 2022 204 799.0

(51) Int. Cl. B01D 53/88; B03C 3/66; F23B 80/04; F23J 15/02

(52) U.S. Cl. CPC B01D 53/885; B03C 3/66; F23B 80/04; F23J 15/022; B01D 2258/0283

(57) ABSTRACT

A heat-resistant body has a cavity for exhaust gas, which is open at opposite ends. The body has first wall portions, each of which delimits a first portion of the cavity. Each first wall portion has an outer region and an inner region which has planar protrusions which each extend from the outside region inward into the associated first cavity portion, the planar protrusions tapering along the longitudinal extent in their width directed perpendicularly to the longitudinal extent and being mutually laterally spaced. Each planar protrusion of a first wall portion is rotated or shifted relative to a planar protrusion of an adjacent first wall portion. The body has second wall portions, each of which delimits a second portion of the cavity and is disposed between two adjacent first wall portions. The cross-sectional area of each second cavity portion is larger than the cross-sectional area of each first cavity portion.

### CROSS-REFERENCE TO RELATED APPLICATIONS

This application is a continuation of PCT/EP2023/062728 filed May 12, 2023, which claims priority under 35 USC § 119 to German patent application 10 2022 204 799.0 filed May 16, 2022. The entire contents of each of the above-identified applications are hereby incorporated by reference.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 shows a prior art exhaust gas treatment device;

FIG. 2 shows a further exhaust gas treatment device according to the prior art;

FIG. 3 shows a first exemplary embodiment of the exhaust gas treatment device;

FIG. 4 illustrates a second exemplary embodiment of the exhaust gas treatment;

FIG. 5 shows the exhaust gas aftertreatment device ready for operation;

FIG. 6 shows a sectional view of the body;

FIG. 7 shows a top view of first wall portions in a first variant;

FIG. 8 shows a top view of first wall portions in a second variant; and

FIG. 9 shows a top view of second wall portions.

### DETAILED DESCRIPTION

The invention relates to an exhaust gas treatment device for treating exhaust gas from a combustion process, comprising a heat-resistant body having a cavity which is open at opposite ends and intended for the exhaust gas to flow therethrough, and having a plurality of first wall portions, each of which delimits a respective first portion of the cavity and has an outer region and an inner region consisting of a plurality of planar protrusions, all of which extend from the outer region inward towards a central region of the respective first cavity portion, taper towards the central region with regard to width directed transversely to a longitudinal axis of the cavity and are mutually laterally spaced, each first wall portion being rotated relative to a respectively adjacent first wall portion by a predeterminable angle in a direction which is the same for each first wall portion.

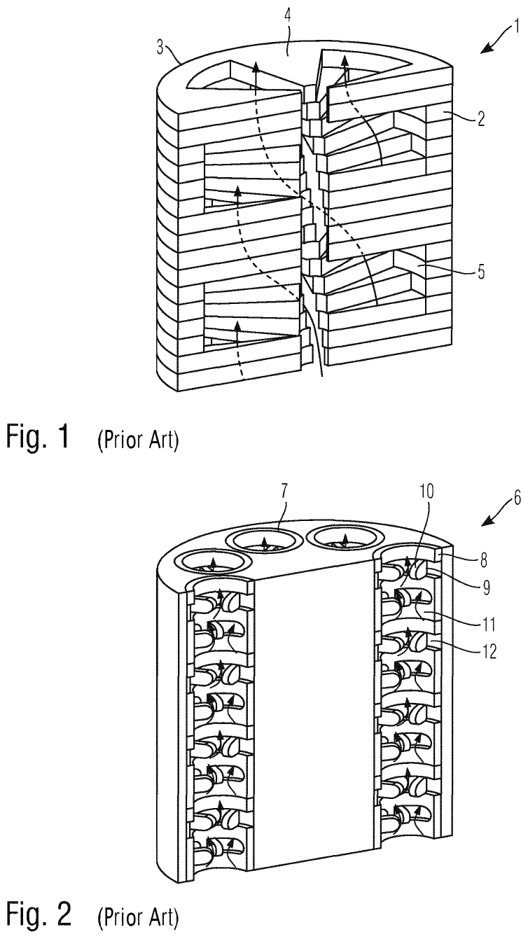

An exhaust gas treatment device of this type is known from DE 10 2019 218 807 A1 and is also described and illustrated in unpublished German patent application DE 10 2021 205 653.9. In this exhaust gas treatment device, the heat-resistant body is composed exclusively of first wall portions which are stacked on top of one another and each of which is a respective disk-shaped element which is rotated by a predeterminable angle relative to the immediately adjacent disk-shaped element of the stack. As a result, the intermediate spaces formed by the lateral distances between the protrusions of the respective disk-shaped element are partially covered by the protrusions of the immediately adjacent disk-shaped element. This arrangement of the disk-shaped elements subdivides the cavity of the body through which the exhaust gas is to flow into a plurality of helical flow channels extending between the opposite ends of the body, the respective walls of which flow channels are stepped like a circular staircase, the number of flow channels corresponding to the number of protrusions which each disk-shaped element has in equal numbers. In the illustrated example of the known exhaust gas treatment device, the number of protrusions on each disk-shaped element is four, resulting in a total of four helical circular staircase-stepped flow channels for the exhaust gas that flows therethrough between the opposite ends of the body. Due to this shape and arrangement of the flow channels in the body, the exhaust gas entering the channels at one end of the body experiences a substantially helical, turbulent path through each of the flow channels on its way to its other end of the body, the roughness of the surface of the wall of the flow channels, which is created by the steps in the wall of the flow channels, further increasing the turbulence of the exhaust gas flow. FIG. 1 of the accompanying drawings schematically shows a longitudinal section through the body of a known exhaust gas treatment device, the exhaust gas flows directed from bottom to top through the helical, circular staircase-shaped flow channels being indicated by partially dashed, helical arrows.

Although this known exhaust gas treatment device achieves a significantly more efficient exhaust gas purification compared to another known exhaust gas treatment device in which the exhaust gas is guided through a plurality of Pall rings stacked on top of one another, as is the case with the exhaust gas treatment device known from DE 20 2016 100 216 U1 or with the exhaust gas treatment device known from WO 2014/198758 A1, there is, in the case of a separation and deposition of fine dusts, a need for a more intensive fine dust separation and deposition, in particular when the exhaust gas treatment device is used in smaller single-room heating systems.

FIG. 2 of the attached drawings schematically shows a longitudinal section through a known exhaust gas treatment device having multiple flow channels, each of which is formed by a plurality of Pall rings stacked on top of one another, the multiply deflected flow path of the exhaust gas directed through the Pall rings being indicated by arrows. In the Pall rings of the known exhaust gas treatment device, longitudinal portions having finger-shaped protrusions that are directed radially inwards, are spaced apart in the circumferential direction and have a constant thickness in the circumferential direction, alternate in the longitudinal direction of the flow channels with longitudinal portions having a smooth cylindrical inner wall. In the circumferential direction next to each protrusion there is a recess in the wall of the respective longitudinal portion on one side in each case. As a result, the size of the cross-sectional area of the respective cavity remains constant over the entire length of the respective stack of Pall rings so that despite the multiple deflection of the exhaust gas flow, the flow velocity of the exhaust gas flow between the inlet and outlet of the respective stack of Pall rings remains substantially constant and the separation and deposition of fine dust on the inner wall of the Pall rings is only moderate, in particular when they are used in single-room heating systems.

Therefore, the object of the invention is to further develop an exhaust gas treatment device of the type described at the beginning so as to increase the separation and deposition of fine dust in the cavity of the body of the exhaust gas treatment device through which exhaust gas flows.

The object of the invention is achieved in that the body of the exhaust gas treatment device has a plurality of second wall portions, each of which delimits a respective second portion of the cavity and is arranged in each case between two adjacent first wall portions, the cross-sectional area of each second cavity portion being larger than the cross-sectional area of each first cavity portion.

Due to the expansion of the cross-sectional areas of the second cavity portions compared to the cross-sectional areas of the first cavity portions, zones with reduced flow velocity of the exhaust gas conducted through the cavity are created in the second cavity portions, which exhaust gas is accelerated again in the first cavity portions due to the smaller cross-sectional area existing therein. The alternating deceleration and re-acceleration of the exhaust gas flow in its flow channel formed by the cavity of the body causes additional turbulence of the exhaust gas flow in the second cavity portions. At the same time, the dwell time of the exhaust gas in the exhaust gas treatment device is increased, making the purification of the exhaust gas even more efficient overall. The additional turbulence of the exhaust gas flow and the reduction of the flow velocity in the second cavity portions considerably favor the separation and deposition of fine dust particles in the cavity of the exhaust gas treatment device according to the invention, so that significantly more fine dust can be separated and deposited than is possible with the known exhaust gas treatment devices.

The exhaust gas treatment device according to the invention can be used in particular in biomass fireplaces in technical building equipment. For example, the exhaust gas treatment device is suitable for small combustion installations, such as wood-burning stoves or tiled stoves or kitchen stoves. In other embodiments of the invention, the exhaust gas treatment device is suitable for boilers of a central heat supply, which is operated, for example, with firewood or pellets or wood chips. For this purpose, the exhaust gas treatment device is preferably installed in the respective small combustion installation. In this case, the exhaust gas treatment device can be optimized for future use with little effort.

The invention is explained in more detail below on the basis of the description of exemplary embodiments and with reference to the accompanying drawings. In the drawings,

FIG. 1 shows a schematic longitudinal section through the body, shown in perspective, of an exhaust gas treatment device according to the prior art, the continuous helical path of the exhaust gas flows through the helical flow channels which are stepped like a circuit staircase and which are formed by disk-shaped elements that are stacked on top of one another being indicated by partially dashed arrows;

FIG. 2 shows a schematic longitudinal section through the body, shown in perspective, of an exhaust gas treatment device according to the prior art, the body of the exhaust gas treatment device having a plurality of Pall rings stacked on top of one another in a plurality of stacks spaced from one another in the circumferential direction and the path of the exhaust gas flows through the flow channels that are delimited by Pall rings being indicated by arrows; and

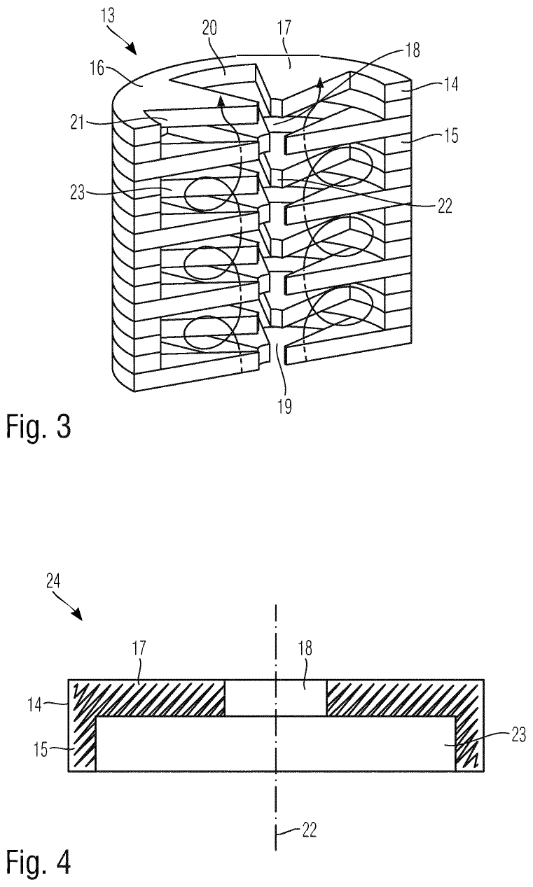

FIG. 3 shows a schematic longitudinal section through the body, depicted in perspective, of a first exemplary embodiment of an exhaust gas treatment device according to the invention, first wall portions having radially inwardly protruding, circumferentially spaced-apart, planar protrusions alternating with second wall portions having smooth cylindrical walls in the longitudinal direction of the body and the multiple changes in direction and vortex formations of the exhaust gas flow on its path from bottom to top through the cavity of the body being indicated by partially dashed arrows.

FIG. 4 shows a schematic longitudinal section through first and second wall portions according to a second embodiment.

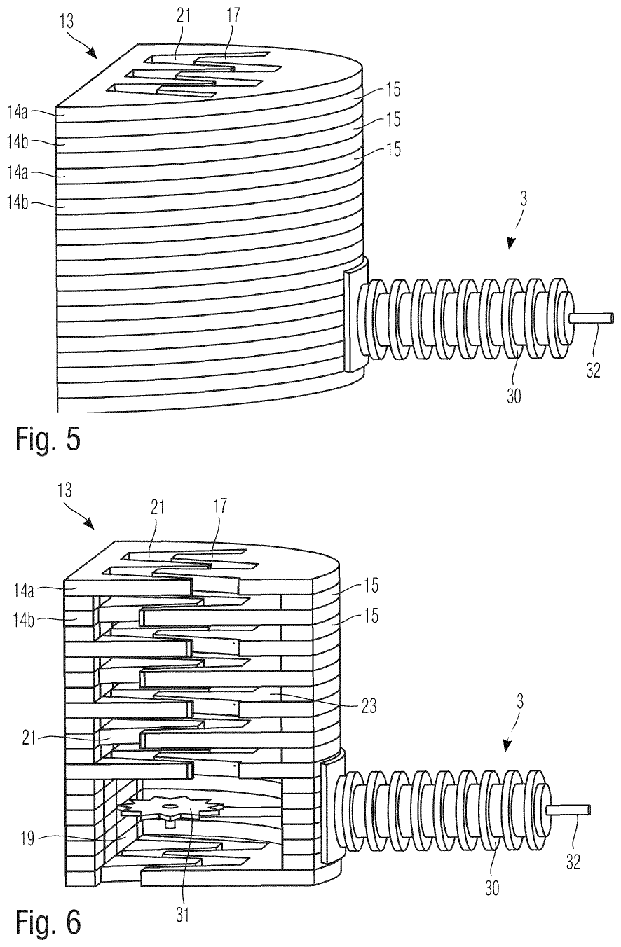

FIGS. 5 to 9 show a third exemplary embodiment of an exhaust gas treatment device according to the invention.

The reference signs used in the drawings (FIGS. 1 to 9) have the following meanings:

### In FIG. 1:

1 body
2 disk-shaped element
3 annular region
4 protrusions
5 flow channels

### In FIG. 2:

6 body
7 stack
8 Pall rings
9 first wall portion
10 protrusions
11 second wall portion
12 recess

### In FIGS. 3 to 9:

13 body
14 first wall portion
15 second wall portion
16 outer region
17 protrusion
18 central region
19 cavity
20 partial region
21 first cavity portion
22 longitudinal axis
23 second cavity portion
3 electrostatic dust separation
30 insulator
31 spray electrode
32 connecting electrode

As can be seen in the drawings, FIG. 1 shows a prior art exhaust gas treatment device in which the body 1 of the exhaust gas treatment device includes a plurality of disk-shaped elements 2 which are stacked on top of one another and which have a plurality of radially inwardly protruding planar protrusions 4 which extend from an outer annular region 3 and which are spaced from one another in the circumferential direction, the disk-shaped elements 2 being rotated relative to one another by a predeterminable angle so that a plurality of helically coiled flow channels 5 are formed, through which the exhaust gas to be treated flows helically from bottom to top and, in so doing, is swirled, as is indicated by the partially dashed arrows.

FIG. 2 shows a further exhaust gas treatment device according to the prior art, in which the body 6 of the exhaust gas treatment device has a plurality of stacks 7 of Pall rings 8 which are stacked on top of one another and each of which has a first wall portion 9 with finger-shaped protrusions 10 protruding radially inwards from the wall and a second wall portion 11 adjoining the first wall portion 9 and having a smooth cylindrical inner wall. A recess 12 is located on the side of each protrusion 10. Each stack 7 of Pall rings 8 forms a flow channel through which the exhaust gas to be treated is passed from bottom to top and is deflected many times and, in so doing, is swirled, as is indicated by the arrows.

The reduction in the cross-sectional area of the flow channel due to the radially inwardly protruding finger-shaped protrusions 10 of the first wall portions 9 of the Pall rings 8 is again compensated for by the recesses 12 so that the cross-sectional area of the flow channel in the first wall portions 9 is the same as that in the second wall portions 11. As a result, the flow velocity of the exhaust gas flows also remains substantially constant over the entire height of the body 6.

The body 6, which is composed of Pall rings 8, has a mass of about 2 kg to about 3 kg.

FIG. 3 shows a first exemplary embodiment of the exhaust gas treatment device according to the invention. It includes a body 13 which has a plurality of first wall portions 14 and a plurality of second wall portions 15, the first and second wall portions 14, 15 being thin disks having two different cross-sections and being arranged in a stack and alternate in sequence. This means that a second wall portion 15 is arranged between two adjacent first wall portions 14 each. In the illustrated example, each wall portion 14, 15 is formed by a respective disk-shaped element that has a cylindrical surface on the outside. Alternatively, the outer surface of the disk-shaped elements can also be polygonal or elliptical. However, all wall portions 14, 15 can also be made of a single one-piece block which, like the disk-shaped elements, can be cylindrical, as shown, or polygonal on the outside.

Each first wall portion 14 has an outer, in the example annular, region 16 and an inner region comprising a plurality of planar protrusions 17, each of which extends from the outer region 16 radially inwards towards a central region 18 of the cavity 19 formed in the body 13 and tapers in its width directed transversely to a central longitudinal axis 22 of the cavity 19 from the outer region 16 towards the central region 18. In contrast, the thickness of each protrusion 17 directed parallel to the longitudinal axis 22 of the cavity 19 is constant in the illustrated example. The planar protrusions 17 are spaced from one another in the circumferential direction, as a result of which an approximately triangular partial region 20 of the first cavity portion 21 delimited by each first wall portion 14 is formed between two adjacent protrusions 17 of the first wall portion 14 in each case. In the illustrated example, each first wall portion 14 has four protrusions 17 of the same shape and size. Accordingly, there are four partial regions 20 of the same shape and size between the protrusions 17 of the first wall portion 14. Alternatively, however, more or fewer protrusions than four, e.g. three, five or six protrusions, can also be provided.

The protrusions 17 of the first wall portion 14 are arranged in a substantially horizontal fashion. In some embodiments of the invention, the angle between the longitudinal axis 22 and a vector lying in the plane of the protrusions 17 can be between about 85° and about 95°, or between about 87° and about 93°, or between about 89° and about 91°.

In some embodiments of the invention, the central region 18 can have a diameter of about 1 mm to about 150 mm. In some embodiments of the invention, the central region 18 can also be omitted. In some embodiments of the invention, the central region 18 can be omitted after the first wall portions 14 have been manufactured, i.e. the tips of the protrusions 17 of the first wall portion 14 are in contact. This does not preclude thermal stresses during the use of the exhaust gas after-treatment device from breaking this connection between the tips of the protrusions 17 of the first wall portions 14, thereby forming a central region 18.

In some embodiments of the invention, a flow can pass through the body 13 from a first end, shown in the lower part in FIG. 3, to its second end, shown in the upper part in FIG. 3, without reversing the flow. In some embodiments of the invention, a frame (not shown) can be provided at the inlet and covers the central region 18. This can reduce or prevent the ingress of flue gases into the central region 18 during normal operation. Only when the exhaust gas path is blocked by soot or dust does the flue gas penetrate into the central region 18 due to the resulting exhaust gas back pressure, which in this way prevents a backflow into the building.

Each second wall portion 15 arranged in each case between two adjacent first wall portions 14 delimits a second cavity portion 23 of the cavity 19, which has a cylindrical shape. Alternatively, the second cavity portion can also have a polygonal shape. Each inner delimiting surface of the outer region 16 of the respective first wall portion 14, which inner delimiting surface extends in the circumferential direction between two respective protrusions 17 adjacent in the circumferential direction, has the same radius of curvature as the inner cylindrical delimiting surface of the respective second wall portion 15, these two delimiting surfaces having a stepless transition between them in the axial direction. However, the transition between these two delimiting surfaces can also be stepped if, as provided in an alternative exemplary embodiment (not shown), the diameter of the second cavity portion 23 is larger or smaller than the diameter between two opposite delimiting surfaces of the outer region 16 of the respective first wall portion 14. Alternatively, a stepped transition between the delimiting surface of the outer region 16 of the first wall portion 14 and the inner delimiting surface of the adjacent second wall portion 15 can be created by a rectilinear course of the delimiting surface of the outer region 16 of the first wall portion 14 and/or by a polygonal course of the inner delimiting surface of the second wall portion 15. A stepped transition between these two delimiting surfaces in the axial direction promotes turbulence and mixing of the exhaust gas in the cavity 19.

Each first wall portion 14 is rotated by a predetermined angle relative to the first wall portion 14 adjacent in the axial direction. In the illustrated exemplary embodiment, the angle of rotation is 45°. Alternatively, a different angle of rotation can also be selected for the first wall portions 14. Preferably, the alternative angles of rotation are in the range between 30° and 60°. For example, the angle of rotation is 30°, 36°, 45° and 60° for a number of 6, 5, 4 and 3 protrusions of the first wall portions 14, respectively.

Due to the fact that each second cavity portion 23 has a fully cylindrical shape and each first cavity portion 21 only consists of the partial regions 20 arranged between the protrusions 17 and the relatively small central region 18, the cross-sectional area of each second cavity portion 23 is in any case significantly larger than that of each first cavity portion 21 in the base of the same or similarly large diameters of these cavity portions 21 and 23. The relatively larger cross-sectional areas of the second cavity portions 23 each form zones with a lower flow velocity of the exhaust gas, whereas the relatively smaller cross-sectional areas of the first cavity portions 21 cause a higher flow velocity of the exhaust gas in the first cavity portions 21. Since the first wall portions 14 and thus the first cavity portions 21 alternate with regard to their arrangement in the longitudinal direction of the cavity 19 with the second wall portions 15 and the associated second cavity portions 23, the exhaust gas flowing through the cavity 19 is alternately decelerated and accelerated again, depending on whether it is currently flowing through a second cavity portion 23 which has a larger cross-section or through a first cavity portion 21 which has a smaller cross-section. This alternating deceleration and re-acceleration of the exhaust gas as it flows from bottom to top through the cavity 19 of the body 13 causes increased turbulence of the exhaust gas, in particular in the second cavity portions 23, as is indicated by the flow arrows in FIG. 3. At the same time, the separation and deposition of fine dust in the second cavity portions 23, through which the flow is slower, is promoted.

The rotational angle offset between the first wall portions 14 causes a frequent flow deflection of the exhaust gas on its path from bottom to top through the cavity 19, as can also be seen from the flow arrows in FIG. 3. This frequent flow deflection of the exhaust gas on its path through the cavity 19 also contributes to the turbulence of the exhaust gas.

The rotational angle offset between the first wall portions 14 also has the further effect that the fully cylindrical second cavity portions 23 are partially covered by the protrusions 17 of the respectively adjacent first wall portions 14. In particular, the protrusions 17 following a second cavity portion 23 in the direction of flow represent baffle surfaces on which the exhaust gas impinges, which not only favors the turbulence of the exhaust gas but also the separation and deposition of fine dusts on the protrusions 17.

The first and second wall portions 14 and 15 can all have a thickness of about 5 mm to about 50 mm or of about 5 mm to about 15 mm. In other embodiments of the invention, the first and second wall portions 14 and 15 can all have a thickness of about 5 mm about 8 mm. In other embodiments of the invention, the first and second wall portions 14 and 15 can all have a thickness of about 6 mm to about 10 mm. In yet other embodiments of the invention, the first and second wall portions 14 and 15 can all have a thickness of about 25 mm to about 50 mm. In some embodiments of the invention, the overall height of the body 13 can be between about 12 cm and about 20 cm. In other embodiments of the invention, the overall height of the body 13 can be between about 15 cm and about 25 cm. In yet other embodiments of the invention, the overall height of the body 13 can be between about 16 cm and about 20 cm. The exhaust gas treatment device according to the invention can thus be flexibly adapted to different operating conditions or customer requirements.

The thickness of the second wall portions 15 can be between about 0.8 to about 5 or between about 0.8 to about 3 times the thickness of the first wall portions 14. In some embodiments of the invention, the first and second wall portions 14 and 15 can be of equal thickness.

In some embodiments, the mass of the body 13 can be between about 7 kg and about 10 kg. Due to the increased mass and the associated increased heat capacity, temperature fluctuations of the exhaust gas treatment device are compensated so that with fluctuating energy input from the combustion process, smaller temporal fluctuations of the pollutant concentration occur and a good cleaning effect is obtained even at low load.

Compared to known exhaust gas treatment devices, the exhaust gas treatment device according to the invention has the advantage that a stable flow with longer dwell times can be achieved due to the defined flow channel. In addition, a predeterminable surface roughness can be set.

In some embodiments of the invention, at least a partial area of the body 13, which comes into contact with exhaust gas as intended during the operation of the exhaust gas treatment device, can be provided with a coating. A coating of this type can be catalytically active or contain a catalyst. A catalyst of this type can be arranged and intended to promote or even render possible the oxidation of hydrocarbons and/or carbon monoxide in the exhaust gas. In some embodiments of the invention, a catalyst of this type can contain or consist of platinum and/or palladium. The catalyst can be applied by vapor deposition and/or sputter coating and/or plasma spraying and/or as a washcoat. This can reduce the pollutant content of the exhaust gas.

FIG. 4 illustrates a second exemplary embodiment of the exhaust gas treatment device according to the invention. Identical components of the invention are followed by the same reference signs so that the below description is limited to the substantial differences.

The second embodiment differs from the above described first embodiment in that the body 13 is composed of a plurality of similar disks 24, each of which combines a first wall portion 14 and a second wall portion 15 in one piece. This can simplify the design of the exhaust gas treatment device because only one type of disk 24 with the correct angle of rotation offset to one another needs to be stacked on top of one another in order to produce the exhaust gas treatment device in the desired length. In order to ensure the correct angle of rotation offset, the disks can be provided with holes and pins which are interlockingly engaged when stacked so that the disks 24 are aligned on top of one another in a predeterminable manner.

FIGS. 5 to 9 depict in more detail a third exemplary embodiment of an exhaust gas treatment device according to the invention. Identical components of the invention are followed by identical reference signs so that the below description is limited to the substantial differences.

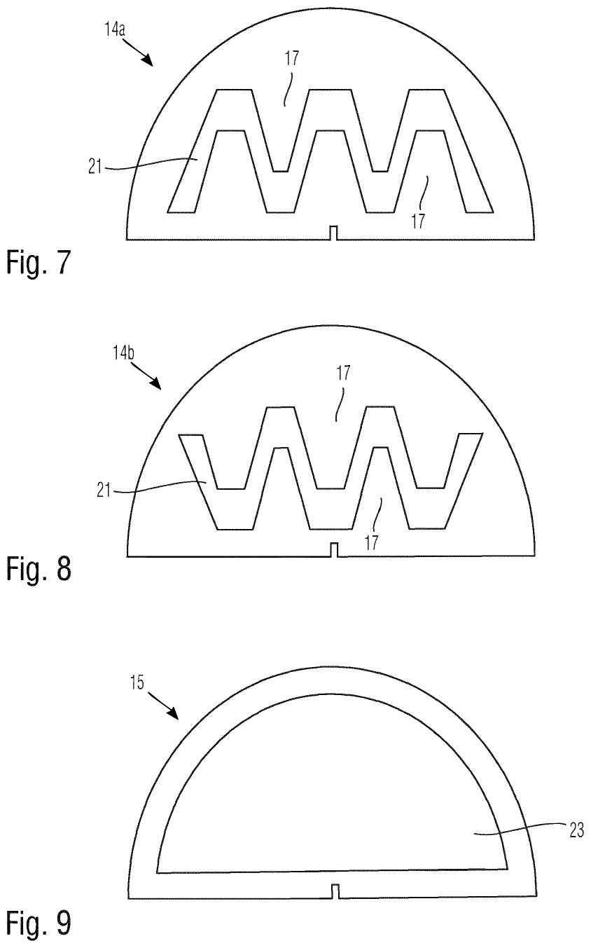

In this connection, FIG. 5 shows the exhaust gas aftertreatment device ready for operation, FIG. 6 shows the body 13 in section, FIG. 7 shows a top view of first wall portions 14a in a first variant, FIG. 8 shows the top view of first wall portions 14b in a second variant, and FIG. 9 shows the top view of second wall portions 15. The third embodiment uses two different first wall portions 14a and 14b, which are inserted alternately in the body 13 and are each separated from one another by a second wall portion 15. The outer contour is not cylindrical as in the first exemplary embodiment but has approximately the shape of a half ellipse having a straight outer edge.

As is in particular clear from FIGS. 7 and 8, the protrusions 17 are not arranged radially but rather linearly next to one another. The protrusions 17 with the base on one side of the plate forming the wall portion 14a, 14b here engage in the protrusions 17 with the base on the opposite side of the plate forming the wall portion 14a, 14b in a comb-like manner. The protrusions 17 of the first wall portions 14a in the first variant are shifted by about half a base length relative to the protrusions 17 of the first wall portions 14b in the second variant so that the first cavity portions 21 of the first wall portions 14a in the first variant are covered by the protrusions 17 of the first wall portions 14b in the second variant and vice versa. This feature has the same effect as the angular offset described above in connection with the first exemplary embodiment so that the turbulence in the flue gas is increased and the dwell time is extended.

As shown in FIG. 9, each second wall portion 15 in the third exemplary embodiment also has a perforated disk having at least one hole forming the second cavity portion 23.

In some embodiments of the invention, the exhaust gas aftertreatment device can furthermore have a device 3 for electrostatic dust separation. This device comprises at least one spray electrode 31, which is arranged in the cavity 19 and is designed to expose the flue gas to an electric field. The spray electrode can be made of a metal or an alloy. The spray electrode 31 can be provided with an optional coating which, for example, renders possible a dielectrically impeded discharge and/or reduces the work function for electrons and/or prevents or reduces the oxidation or contamination of the spray electrode. In one embodiment, the spray electrode can have approximately the shape of a second wall portion 15, i.e. form an annular longitudinal portion of the body 13. In other embodiments of the invention, the spray electrode 31 can be rod-shaped or planar and extend along the longitudinal extension of the body 13, for example on the longitudinal axis 22 thereof.

During the operation of the exhaust gas treatment device, the spray electrode is connected via an electrical conductor 32 to a high-voltage source (not shown). The lead-through of the external conductor 32 into the cavity 19 to the spray electrode 31 can be carried out by means of an insulator 30.

The high-voltage source can obtain a primary voltage by means of a power cable or with battery operation or by a thermal generator and deliver a high voltage at its output, which is, for example, more than 10 kV or more than 15 kV or more than 20 kV or more than 30 kV. The high voltage can be less than 100 kV or less than 50 kV or less than 35 kV. In some embodiments of the invention, the field strength at the spray electrode can be between about 1 kV/mm and about 7 kV/mm or between about 0.7 kV/mm and 5 kV/mm. The current provided by the high-voltage source can be between about 0.1 mA and about 10 mA or between about 1 mA and about 5 mA or between about 0.2 mA and about 5 mA or between about 1 mA and about 3 mA. The power provided by the high-voltage source can be between about 20 W and about 100 W or between about 25 W and about 40 W or between about 5 W and about 200 W. It has been shown that the output of ultrafine dusts is already reduced by more than 80% at only 20 W electrical power, the cleaning effect increasing even further at higher power.

When the high-voltage source is in operation, the spray electrode 31 thus generates an electric field. The flue gases flowing in the cavity 19 pass through at least one longitudinal portion in the exhaust gas aftertreatment device, in which they are exposed to an electric field. The electric field can support the agglomeration of fine dusts and thus the conversion of fine dust to coarse dust. In addition, the electrically charged fine dusts can adhere electrostatically to the walls of the body 13 and thus be filtered out of the exhaust gas flow. This measure can thus further increase the effectiveness of the exhaust gas aftertreatment device according to the invention.

In some embodiments of the invention, the spray electrode 31 can be designed to generate ozone and/or atomic oxygen from the residual oxygen so that pollutants and dusts can be oxidized efficiently.

### Comparative Example

The invention shall be explained below by means of a comparative example. For this purpose, a small combustion installation in the form of a wood-burning stove for living rooms is operated with firewood. It was operated once with and once without the exhaust gas treatment device according to the invention. The pollutant emissions of the small combustion installation are recorded in each case.

The small combustion installation emits 15·10⁶ particles/(s·cm³) of ultrafine dust having a particle size of 20 nm to 350 nm without the exhaust gas treatment device according to the invention. When the exhaust gas treatment device according to the invention is used, the emission of ultrafine dust is reduced to 8·10⁶ particles/(s·cm³). If a spray electrode is additionally used in the exhaust gas treatment device and an electrical voltage of 25 kV at an electrical power of 30 W is applied thereto, the emission of ultrafine dust is further reduced to 4·10⁶ particles/(s·cm³).

The emission of coarse dust having a particle size of more than 10 μm could be reduced by 60% when using the exhaust gas treatment device according to the invention. A considerable reduction would also be achieved for gaseous pollutants, such as CO and CₙHₓ, which moreover remained constantly low even with fluctuating thermal output of the small combustion installation.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

Of course, the invention is not limited to the indicated embodiments. Therefore, the above description should not be regarded as limiting but as explanatory. The below claims should be understood as meaning that an indicated feature is present in at least one embodiment of the invention. This does not exclude the presence of further features. Insofar as the claims and the above description define “first” and “second” embodiments, this designation is used to distinguish between two embodiments of the same kind without establishing an order of priority.

1. An exhaust gas treatment device for treating an exhaust gas from a combustion process, comprising a heat-resistant body delimiting a cavity which is open at opposite ends and intended for the exhaust gas to flow therethrough, the body having a plurality of first wall portions, all of which delimit a respective first portion of the cavity, each first wall portion having an outer region and an inner region, which has a plurality of planar protrusions, all of which extend from the outer region inward into the respective first cavity portion, the planar protrusions tapering along the longitudinal extension in their width directed transversely to the longitudinal extension and being mutually laterally spaced, each planar protrusion of a first wall portion being rotated or shifted relative to a planar protrusion of an adjacent first wall portion,
wherein the body has a plurality of second wall portions, each of which delimits a respective second portion of the cavity and is arranged in each case between two adjacent first wall portions, the cross-sectional area of each second cavity portion being larger than the cross-sectional area of each first cavity portion.

2. The exhaust gas treatment device of claim 1, wherein the first wall portions and the second wall portions have a cylindrical shape and/or wherein each second wall portion of the body is a plate having at least one cylindrical hole which forms the second cavity portion.

3. The exhaust gas treatment device of claim 2, wherein the diameter of each second cavity portion is larger than the distance between two opposite inner delimiting surfaces of the outer region of the respective first wall portion, the opposite inner delimiting surfaces of the outer region being curved transversely to the longitudinal axis of the cavity or extending in a straight line.

4. The exhaust gas treatment device of claim 3, wherein the distance between two opposite inner delimiting surfaces of the outer region of the respective first wall portion is a diameter passing through the center of the first cavity portion.

5. The exhaust gas treatment device of claim 1, wherein the first wall portions and the second wall portions have an elliptical or polygonal shape or wherein the first wall portions and the second wall portions have at least one flat delimiting surface.

6. The exhaust gas treatment device of claim 1, wherein each second wall portion is a perforated disk having at least one hole forming the second cavity portion.

7. The exhaust gas treatment device of claim 1, wherein in each case a first wall portion and an adjacent second wall portion are made in one piece or
wherein the first and/or the second wall portions are each separate individual elements which are stacked along a longitudinal axis of the body, or
wherein the body consists of a single block in which the first and second wall portions are each connected to one another in one piece.

8. The exhaust gas treatment device of claim 1, wherein the thickness of the second wall portions corresponds to between about 0.8 to about 5 times the thickness of the first wall portions.

9. The exhaust gas treatment device of claim 1, wherein the planar protrusions have a thickness of about 5 mm to about 50 mm.

10. The exhaust gas treatment device of claim 1, wherein the total height of the body is between about 12 cm and about 20 cm or
wherein the mass of the body is between about 7 kg and about 10 kg.

11. The exhaust gas treatment device of claim 1, further comprising at least one spray electrode which is configured to expose the exhaust gas flow to an electric field or
further comprising at least one spray electrode which is configured to expose the exhaust gas flow to an electric field of about 0.7 kV/mm to about 7 kV/mm.

12. The exhaust gas treatment device of claim 1, wherein the current supplied to the spray electrode is between about 0.1 mA and about 10 mA or
wherein the power supplied to the spray electrode is between about 20 W and about 100 W or between about 5 W and about 200 W.

13. The exhaust gas treatment device of claim 1, wherein at least one partial surface of the body, which is intended to come into contact with the exhaust gas during the operation of the exhaust gas treatment device, has a coating.

14. The exhaust gas treatment device of claim 13, wherein the coating is catalytically active or contains a catalyst.

15. A small combustion installation comprising an exhaust gas treatment device for treating an exhaust gas from a combustion process, comprising a heat-resistant body delimiting a cavity which is open at opposite ends and intended for the exhaust gas to flow therethrough, the body having a plurality of first wall portions, all of which delimit a respective first portion of the cavity, each first wall portion having an outer region and an inner region, which has a plurality of planar protrusions, all of which extend from the outer region inward into the respective first cavity portion, the planar protrusions tapering along the longitudinal extension in their width directed transversely to the longitudinal extension and being mutually laterally spaced, each planar protrusion of a first wall portion being rotated or shifted relative to a planar protrusion of an adjacent first wall portion,
wherein the body has a plurality of second wall portions, each of which delimits a respective second portion of the cavity and is arranged in each case between two adjacent first wall portions, the cross-sectional area of each second cavity portion being larger than the cross-sectional area of each first cavity portion.
